(19) United States
(12) Patent Application Publication
(10) Pub. No.: US 2013/0089692 A1
(43) Pub. Date: Apr. 11, 2013

(54) Concrete Tile and Method of Manufacturing the Same

(71) Applicant: Louis P. Grasso, JR., New Rockelle, NY (US)

(72) Inventor: Louis P. Grasso, JR., New Rockelle, NY (US)

(21) Appl. No.: 13/269,802

(22) Filed: Oct. 10, 2011

(51) Int. Cl. B32B 3/16; B32B 5/00; B28B 11/14; B32B 13/02

(52) U.S. Cl. 428/47; 428/220; 264/158

(57) ABSTRACT

A concrete tile and method of making a concrete tile are described. The tile is made by the process of (i) creating a concrete mixture including Portland cement, preferably a pozzolanic glass powder from post-consumer recycled glass which is used as a partial replacement for the Portland cement, and an aggregate, (ii) forming the mixture under vibration and compaction in an elongate mold form having a height, a depth and a width, (iii) curing the molded concrete block, and (iv) cutting the cured block parallel to its height and depth, and transverse to its width to form tiles sliced from the block, with first and second parallel faces and a thickness extending between the faces. The tiles are cut to a thickness of between ¼ and ¾ inch. The resulting tile is uniform in material properties throughout its construction, and is particularly suitable for use on walls and floors.

### BACKGROUND OF THE INVENTION

1. Field of the Invention

This invention relates to thin stone-like products and methods of making such products. More particularly, this invention relates to tiles made from concrete and their methods of production.

2. State of the Art

Glass powder has been produced for years in limited quantities and is available to some extent for industrial applications. At present, the majority of glass powder is created in bulk from fiberglass raw material rejects and industrial waste from a fiberglass manufacturing operation, both of which are available in only selected locations. Increasing transportation costs have made it desirable to use glass that is available locally. This fact, and the glut of post-consumer waste glass available, makes post-consumer waste glass a logical choice for manufacture of glass powder. However, post-consumer waste glass has drawbacks as a feedstock, in particular its tendency to be contaminated with various foodstuffs and chemical residues, and to be mixed with trash, including labels and other paper scraps, as well as ceramic, plastic, and metal items of various sorts.

More specifically, for some years it has been commonplace for consumers to be expected to sort out empty glass containers for recycling. Ideally, this waste glass would be recycled as new containers. However, post-consumer waste glass is most often produced in various colors (clear, green, and brown being the most common) and cannot be sorted economically either manually or by automated equipment. Moreover, post-consumer waste glass tends to be mixed with plastic and ceramic waste, as well as undifferentiated trash. The difficulty of separating the glass from these other materials and separating the glass into its various colors has precluded efficient recycling of glass into new containers; as a result, most waste glass is now disposed of in landfills, a highly inefficient and undesirable end for this valuable material.

U.S. Pat. No. 7,775,466 to Grasso, Jr. et al. teaches a method of efficiently processing mixed color post-consumer waste glass into a clean dry fine powder of uniform color. The processes overcomes certain obstacles of the post-consumer source materials containing contamination from residual substances, as well as the post-consumer source materials being of mixed color. Further, the resulting glass powder is a pozzolan that does not require any additives to suppress an alkali-silica reaction (ASR). This issue is discussed in more detailed in the referenced patent. The patent teaches that various concrete products can be manufactured with a concrete mix containing Portland cement, the processed fine glass powder partially substitute for a portion of Portland cement, aggregate and water. The component materials are mixed in a mixer under simultaneous vibration and compaction in steel molds and formed into various shapes and sizes specifically for the structural masonry building materials. The molds are removed and the resulting formed products are placed on curing racks to set and then cured. Once the formed masonry products are fully cured, they are packaged and prepared for shipment.

By way of example, concrete blocks are such structural masonry building materials. While the sizes can vary, depending upon application, a common size of block has a nominal measurement of 8 inches high by 8 inches deep by 16 inches wide, and may or may not have an open core which can be provided with fill upon end use. In manufacture of the block, sufficient Portland cement, recycled glass powder and water are combined to form a paste and mixed with a suitable amount of, e.g., ⅝ inch minus to ⅜ inch minus aggregate to form a wet concrete mix. The wet concrete mix is provided into a block mold under vibration and compaction and, once formed, the mold is removed. As the concrete is mixed to have zero slump, the block maintains its form once the mold is removed. The block is then cured.

Thin concrete tiles (on the order of ¼ inch to ¾ inch thick) cannot be manufactured in the manner described with respect to block. First, the aggregate used in structural concrete block is far too large for the thin tiles; i.e., the largest aggregate would be at or exceed the thickness of the tiles, particularly once the aggregate is coated with the concrete paste. Second, given the thinness of the tiles, it is not possible to effectively compact the cement mix into the tiles to form an adequately strong tile.

### SUMMARY OF THE INVENTION

A concrete tile and method of making the concrete tile are provided. The concrete tile is made by the process of (i) creating a concrete mixture including Portland cement, preferably a pozzolanic glass powder from post-consumer recycled glass which is used as a partial replacement for the Portland cement, and an aggregate, (ii) forming the mixture under vibration and compaction in an elongate mold form having a height, a depth and a width, (iii) curing the molded concrete for a pre-set period of time to form a block, (iv) cutting the cured block parallel to its height and depth, and transverse to its width to form tiles sliced from the block, with first and second parallel faces and a thickness extending between the faces. The tiles are cut to a thickness of between ¼ and ¾± 1/16 inch.

The cutting that defines all of the faces—except for the faces defined by the widthwise ends of the block—causes sectioning through at least a portion of the aggregate in the respective face of the tile so that the interior of the aggregate is exposed. Then, optionally, one of the faces of the tile is polished.

Thus, the tile can be poured into a mold because when the block is cut, the entire matrix of the mix is cut including through the aggregates, resulting in tiles uniform in dimension as well as material properties, even if such tile thickness is smaller than permitted by a poured aggregate. Such tile is particularly suitable for use on walls and floors.

The resultant tile, whether or not manufactured with recycled glass powder and/or aggregate has extremely high compressive and flexural strength. The strength is a result of at least the vibration and compaction to which to the concrete mix is subjected while in the mold (but which would not otherwise result if the tile to its final shape and size). In addition, the strength may be in part attributable to the recycled glass powder, and the recycled aggregate. In fact, the concrete tile has a strength that it is at least equal to natural limestone.

In accord with a preferred aspect of the invention, the aggregate in the concrete mixture includes at least a portion of a recycled content, and more preferably post-consumer recycled content, which may contain any of a variety of post-consumer source materials such as post-consumer/post-industrial masonry and concrete. Such content provides multiple advantages. First, the use of recycled aggregate provides a significant environmental benefit over natural virgin and other concrete products. Post-consumer aggregate has been difficult to recycle into commercial products. Yet, by including additional recycled content in the concrete tile, a productive use is provided for the material. Moreover, there are attractions and benefits to architects, builders and tenants for buildings to be manufactured with products using recycled content, including economic and social benefit. Second, the recycled aggregate may result in a concrete tile with even greater strength. It is believed that this may be a result of greater surface area present in certain crushed recycled source materials over natural virgin materials, and also that the recycled aggregate may include unreacted pozzolan which reacts during this second use.

### BRIEF DESCRIPTION OF THE DRAWINGS

FIG. 1 is a flow chart illustrating manufacture of concrete tile according to the invention.

FIG. 2 shows a concrete block used for making the tile of the invention.

FIG. 3 shows a concrete tile according to the invention.

FIG. 4 shows a first composite mosaic cut tile according to the invention.

FIG. 5 shows a second composite mosaic cut tile according to the invention.

### DESCRIPTION OF THE PREFERRED EMBODIMENTS

Concrete blocks are generally made by creating a concrete mix, forming the concrete mix via a molding process, and then curing the cast molded product into blocks. In accord with the invention, the blocks are then cut into tile and surfaces of the cut tile are then finished by shaping or polishing to provide a finished surface.

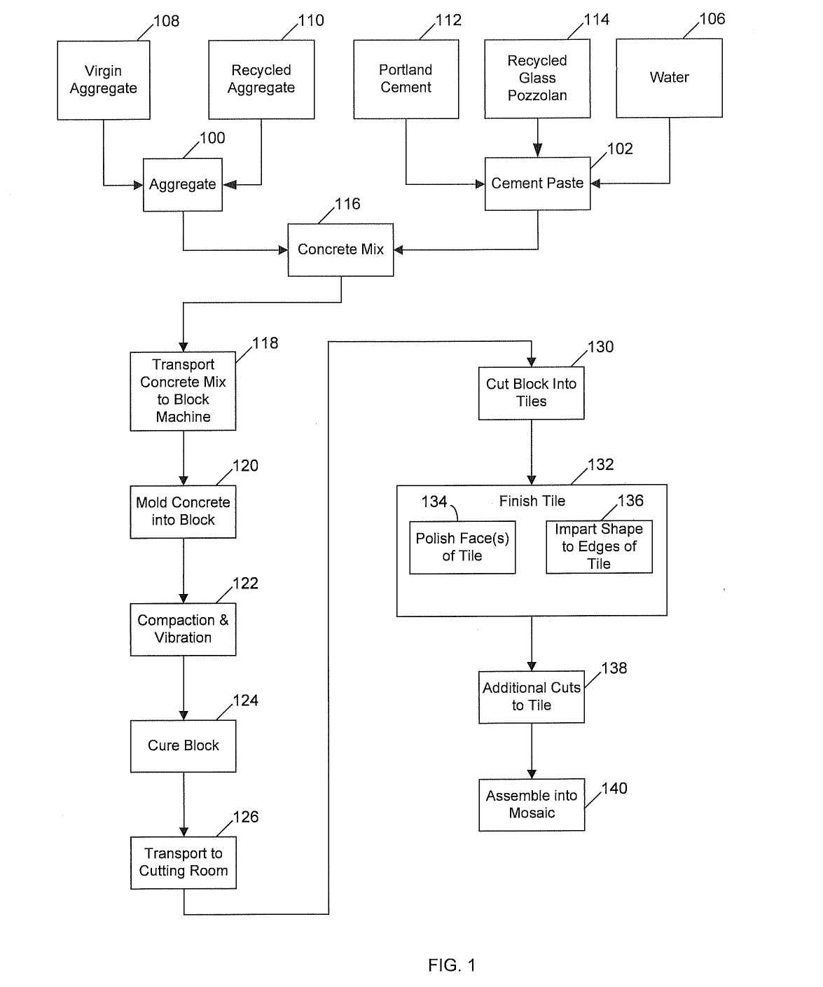

More particularly, referring to FIG. 1, to create the concrete mix 116, aggregate 100 is mixed with a cement paste 102 formed of a pozzolan 104 and water 106. The aggregate 100 is stored outside in piles is transferred into storage bins in a plant by conveyor belt on an as needed basis. The aggregate 100 may be virgin material, preferably gravel having a screened size of ⅝± 1/16 inch minus, more preferably ½ inch minus, and even more preferably ⅜ inch minus. In an embodiment, the aggregate may be considered to have a first portion in which the individual grains have a diameter preferably not exceeding ⅜ inch and a second portion in which the individual grains have a diameter exceeding ⅜ inch but preferably not exceeding ⅝± 1/16 inch. According to another aspect of the invention, the aggregate consists in total or in part of recycled aggregate materials 110, and more particularly post-consumer recycled aggregate. Post-consumer recycled aggregate 110 is provided from previously used concrete block, road bed, sidewalk, products of demolition, etc. It is recognized that such materials are large and bulky and must be crushed to a workable granular size; i.e., preferably ⅝± 1/16 inch minus, more preferably ½ inch minus, and even more preferably ⅜ inch minus.

The pozzolan 104 comprises Portland cement 112 as well an optional partial replacement for a portion of the Portland cement that is preferably comprised of a recycled material. The partial replacement preferably does not exceed forty percent of the pozzolan. The preferred partial replacement is a pozzolanic recycled glass powder 114. Alternatively, but less preferred, fly ash or slag can also be used to manufacture tile having suitable material properties in accord with the invention; however, such non-glass alternative Portland cement replacements have an adverse environmental impact in that the dust created during the cutting of the tile may have additional adverse environmental or health impact, and the tile in use and upon end-of-life demolition or recycling will have potentially dangerous constituents that must be contended with.

The Portland cement 112 is preferably stored inside or outside in large vertical silos to protect it from moisture, and transported for into a cement mixture as needed and discussed below.

The recycled glass powder 114 is preferably a clean, dry, post-consumer recycled glass powder having a substantially uniform size not exceeding 325 mesh. The source for the glass powder is preferably, but not necessarily exclusively, post-consumer replaced windows and a trash stream of mixed color soda lime glass, such as obtained from glass bottles. By ‘clean’ it is meant that all non-glass trash is removed from the post-consumer glass stream used. The post-consumer glass stream may be the stream of post-consumer waste glass as obtained from a typical municipal waste facility or glass harvested from a Leadership in Energy & Environmental Design (LEED) or non-LEED construction site meeting the threshold for Materials and Resources credit 2 (MR-2), Construction Waste Management of the LEED Green Building Design & Construction Reference Guide. By ‘dry’ it is meant that the glass powder contains no more than 2% moisture. A 325 mesh size is believed to be required, or at least preferred, in order to provide the glass powder with desired pozzolanic properties enabling the glass powder to operate as a substitute for up to forty percent of the Portland cement relative to a conventional concrete mixture. The process of processing a mixed color post-consumer soda lime glass stream into a preferred glass powder is described in detail in co-owned U.S. Pat. Nos. 7,775,466 and 7,931,220, both of which are hereby incorporated by reference herein in their entireties. While soda lime glass has a 10-15% alkali content (primarily Na₂O) and a 9-10% CaO, it has been shown to be an effective pozzolan without deleterious short-term or long-term effects on the stability of the concrete. The glass is ground so finely that the sodium and calcium ions diffuse from the particles very rapidly. This is the result of a steep concentration gradient and the fact that these ions are freely available in the interstices of the silica tetrahedrons that makes up the glass. Once in the pore solution, the ions are rapidly incorporated into the calcium silicate hydrate (C—S—H) that cements the aggregates together. The C—S—H permanently chemically binds the sodium and calcium ions so that they are not available to cause damage later. The manufactured recycled glass powder 114 is preferably stored inside or outside in large vertical silos to keep it clean and protect it from moisture, and is transported for mixing on an as needed basis.

As production starts, the required amounts of Portland cement 112 and optional glass powder 114 are transferred by gravity, pneumatically, or by mechanical means to a weigh batcher (or volumetric batcher) that measures the proper amounts of each material. The cement 112 and glass powder 114 are then transported into a stationary mixer where they are blended together for several minutes in combination with the proper amount of water 106 to form the cement paste 102. The mixer may be planetary or pan mixer, or a horizontal drum mixer. The cement paste 102 is combined with the aggregate 100 and further mixed so that the aggregate is fully coated with the paste to form a concrete mix 116. Alternatively, the aggregate 100 may be combined with the Portland cement 112 and optional glass powder 114, and then all of the dry materials are mixed together before water 106 is added. Once the dry materials are sufficiently mixed, the proper amount of water is added, preferably little by little, and the dry and wet components are blended within the mixer to form the concrete mix 116. The amount of water 106 in the mixture 116 is such that the resultant mixture has very low slump. That is, as measured by a concrete slump test according to the ASTM C 143 or EN 12350-2 standards, when an Abrams cone is filled with a sample of the concrete mixture 116 in three layers of equal volume, each layer being tamped to consolidate the layer, removal of the cone should result in a total gravitational slump that should not exceed 2 inches, and more preferably is less than 1 inch.

Optionally, colorants may be added to the concrete mixture 116 for decorative purposes, and other additives may be added for workability or other purposes.

The concrete mixture 16 is then transported to a hopper, from which it is conveyed at 118 to a block machine at a preferably measured flow rate. In the block machine, the concrete is forced downward into block-shaped molds at 120. Multiple blocks may be molded at one time. When the molds are full, the concrete is compacted at 122 by the weight of the upper mold head coming down on the mold cavities. Air or hydraulic pressure cylinders acting on the mold head may supplement this compaction. The block machine also subjects the mold cavities to a burst of mechanical vibration to further aid compaction. The compacted blocks are pushed down and out of the molds onto a pallet. Because of the use of a low slump mixture, the blocks retain their shape. Other methods may be used to manufacture the concrete mixture into the blocks.

The pallets of blocks are conveyed at 124 to an automated stacker or loader which places them in a rack for curing at 126. Each rack may hold several hundred blocks. When a rack is full, it is rolled onto a set of rails and moved into a curing kiln. The kiln may be a low-pressure or high-pressure steam kiln. The process of curing concrete blocks is well known to those skilled in the art of manufacturing concrete building materials.

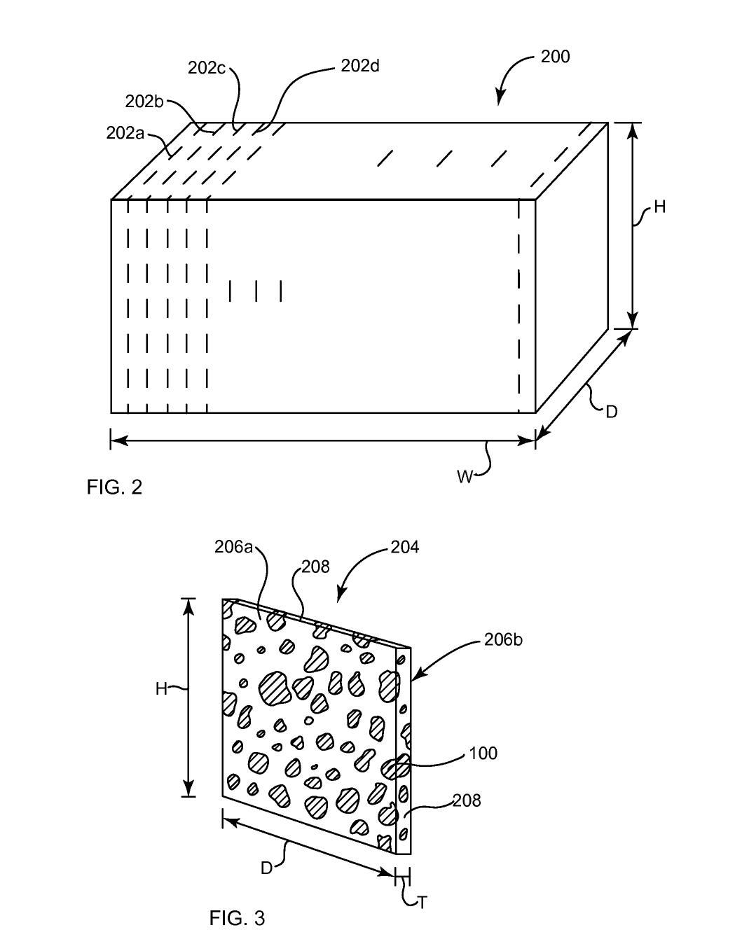

Turning now to FIG. 2, the cured block 200 is preferably a rectangular solid, defining a height H, a depth D, and a width W. For reference, the width is the longest dimension, and the height and depth are generally close in dimension if not substantially the same for block having a square face at its end.

Conventionally, after curing, blocks are cubed, which is a process which aligns each block and then stacks them into a ‘cubes’ of several blocks across by several blocks deep by several blocks high. These cubes are carried outside with a forklift and placed in storage.

Referring to FIGS. 1 and 2, either directly from curing or from storage, the blocks 200 are transported to the cutting room at 128. The blocks are conveyed, lifted, or otherwise moved onto a belt that transports one or more blocks at a time relative to a cutter to cut tiles from the block 130. By way of example, the cutter may be a gang saw with several parallel blades, a rotating or reciprocating round saw blade, a circulating or reciprocating cutting band, a high power water jet, a laser, or any other device or system suitable for slicing or otherwise passing through the block parallel to its height H and depth D, and transverse to its width W to thereby cut tiles from the block, such as along cut lines 202a, 202b, 202c, 202d. The gang saw is preferable as such device includes multiple saw blades that can cut along a plurality of the cut lines to cut a plurality of or even all of the tiles 204 (FIGS. 2 and 3) from one or more concrete blocks 200 at once.

Referring to FIG. 3, each of the tiles 204 cut from the block 200 has a substantially similar thickness T between first and second parallel faces 206a, 206b (the thickness extending in the same direction as the width W of the block, but being the smallest dimension of the tile). The first and second parallel faces 206a, 206b each define the height H and depth D of the tile 204. The tiles 204 are cut to a thickness of between ¼ and ¾± 1/16 inch, and most preferably not exceeding ⅜ inch such that the tile is suitable (e.g., in weight and thickness) for many tiling applications. By cutting the tiles in this manner, it is shown that the aggregate 100 within the block is also sectioned by the saw. Thus each cut face of a tile may have, and will likely have, at least a portion of the aggregate located thereat cut so that the interior of such aggregate is exposed. More specifically, individual pieces of aggregate will have extended on opposite sides of the plane defined by the cut lines 202a, 202b, etc., and then be cut by the saw so as to be located on faces of distinct and separate tiles.

Then, optionally, surfaces of the tile are finished at 132 relative to the finish of the cut surface. A face 206a, 206b of the tile may be polished at 134 via honing or media blasting to present a terrazzo finish. By way of example, a rotating single- or multi-head abrasive tool can be used to polish the face. In addition, routers, water jets, gang saws, single saws, band saws, rope saws, and/or other devices may be used to impart additional shapes to the edges 208 and faces 206a, 206b of the tiles at 136. With finished edges and/or faces, the tile also may be used as boarder or trim pieces, including chair rail, bases and crowns.

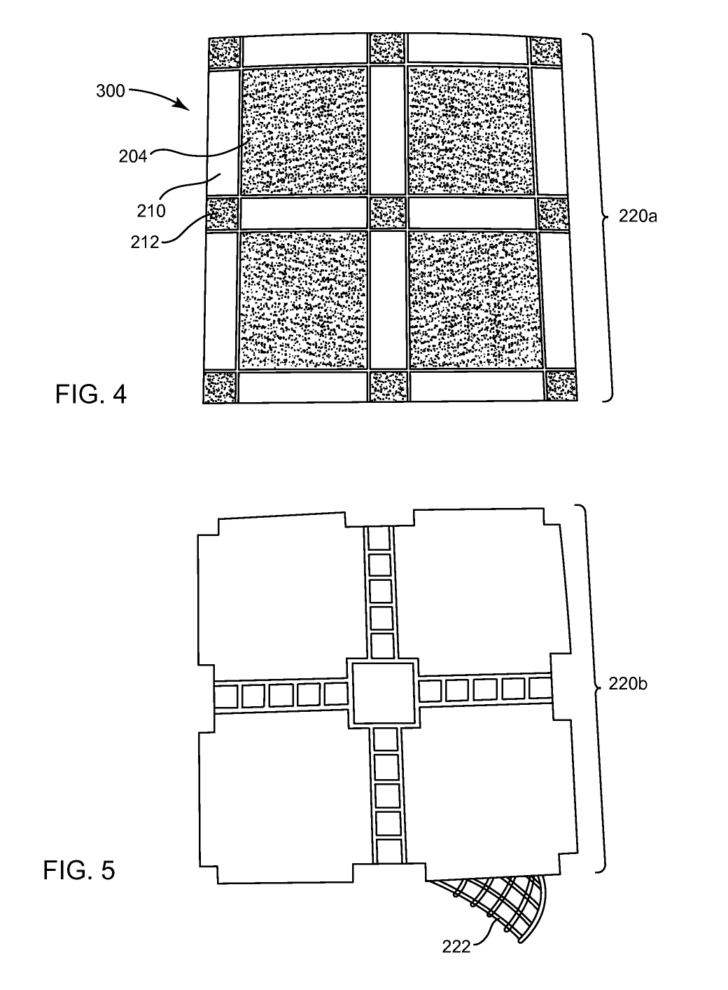

The tiles 204 may be further cut into smaller sizes at 138, with relatively smaller height and/or depth, to define tile pieces 210 that are more relatively elongate than the original block section (height×depth), or cut into multiple tiles of different or similar height×depth ratios as the original block but substantially smaller 212 (FIG. 4). For example, where as the original block may have a height×depth×width relationship of 8 inches×8 inches×16 inches, a first pass tile cut may be dimensioned at 8 inch×8 inches×⅜ inch, and 16 second pass tile pieces may be cut, each with dimensions of 2 inches×2 inches×⅜ inch.

Still referring to FIG. 4, the tiles including first pass full size tiles pieces 204 and second pass cut tile pieces 210, 212 may be arranged either free hand or with specific grid placement in a mosaic 220a. In addition, as shown with respect to another mosaic 220b, the mosaic 220b may be provided to a backing material, such as a rigid or flexible mesh 222, to form a structural mosaic comprising tile pieces of like or different colors, size, and/or shape that may be together handled as a single structural element.

The resulting tiles 204 are uniform in material properties throughout their construction, and have the requisite strength and finish suitable for use on walls and over floors, including subfloors. The tile has similar material properties to medium density limestone and can be used as a manufactured substitute (comprising post-consumer recycled materials) for all uses in which medium density limestone is suitable. Medium density limestone is a common building material often used in thin plates as a façade for building, rather than in stone blocks.

TABLE 1
Comparison of Material Properties of Concrete Tile and Medium Density Limestone

| | Static | Abrasion | Compressive | Flexural Strength | | |
|---|---|---|---|---|---|---|
| | Coef. of | Resistance | Strength | (psi, min) | Density | Absorption |
| | Friction | (min) | (psi, min) | [Tile at 0.4 | (lb/ft³, min) | (%, max) |
| | (wet tested) | ASTM C1353 | ASTM C97 | inch thick] | ASTM C97 | ASTM C97 |
| Cut Concrete | .61 | 26.99 | 5275 (wet) | 748 (wet) | 138.7 | 5.42 |
| Tile #1 | | | 3563 (dry) | 542 (dry) | | |
| Cut Concrete | .63 | 27.92 | 6142 (wet) | 989 (wet) | 137.4 | 5.53 |
| Tile #2 | | | 5004 (dry) | 496 (dry) | | |
| Cut Concrete | .63 | 19.66 | 7388 (wet) | 793 (wet) | 136.0 | 6.04 |
| Tile #3 | | | 4212 (dry) | 598 (dry) | | |
| Poured Concrete | — | — | — | — | — | — |
| Tile | | | | | | |
| Medium Density | >0.60 | 10 | 4000 | n/a | 135 | 7.50 |
| Limestone | | | | | | |

As shown in Table 1, several samples of the concrete tiles 204 according to the invention where subject to measurement and testing for purposes of comparison to medium density limestone. The concrete tile has comparable static coefficient of friction (wet tested) to limestone, similar density and absorbs less moisture. In addition, the concrete tiles have significantly greater abrasion resistance. Further, the compressive strength.

In addition, an attempt was made to manufacture a poured concrete tile (i) at ⅜ inch tile thickness and (ii) at ⅝ tile thickness, using the same concrete mix as the cut concrete tile; i.e., with aggregate ranging in size from ¼ to ⅝ inch. The attempt was made in order to obtain comparative measurements between concrete tiles formed by the two different methods of formation—cut tiles and poured and cured tiles. However, the poured concrete tiles all failed during manufacture. This was due to the fact that it was not possible to pour the concrete mix into the mold in a manner which caused the aggregate to be within the nominal thickness of the tile. In addition, when screening was used to align the aggregate in the poured tile, the aggregates were aligned through the thickness of the tile and the larger size aggregate was exposed relative to the surface of the tile, in effect creating an even thicker tile with an unsuitably rough finish. Further, when downward compression was applied to the aggregate to minimize the tile thickness, the finished product failed upon curing.

In distinction, when the tile is formed by being cut from a larger block that is made under compression in accord with the invention, the aggregates are staggered in displacement throughout the length of the block, and consequently throughout the thickness of the cut tile. This significantly increases the strength of the tile.

While various parts of the disclosure reference the inclusion of recycled materials, including post-consumer recycled aggregate and post-consumer recycled glass powder, into the concrete mix used to make the concrete block from which the tiles are made, it is recognized that the method of manufacturing the tile and the resulting tile may be made without the inclusion of any recycled materials. That is, the Portland cement need not be partially replaced with post-consumer recycled glass, with any recycled materials, or with any other suitable partial replacement material for the resulting tile to still have satisfactory structural properties relative to medium density limestone. Likewise, the aggregate can be completely virgin, the resulting tile will also have satisfactory structural properties relative to medium density limestone. Nevertheless, the inclusion of recycled materials provides a tile product that has significant environmental benefit over natural virgin and other concrete products by providing a productive use for an otherwise non-productive ‘landfill’ material. Moreover, the tile with recycled materials is ‘green’, and as such is an economically and socially attractive tile to architects, builders and tenants. Further, there is some evidence to suggest that the recycled aggregate imparts greater strength on the concrete tile because of greater surface area (relative to virgin aggregate) and the inclusion of non-reacted pozzolan which has a second opportunity to react and contribute strength to the material.

There have been described and illustrated herein embodiments of a concrete tile and a method of manufacturing the tile. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A tile comprising:
a tile having first and second faces, and a thickness extending between the faces, the thickness being between ¼ inch and ¾ inch thick, the tile made of concrete mixed of
i) a first component of an aggregate having a size in which individual grains of the aggregate are at or exceed ¼ inch in diameter, are up to ⅝ inch in diameter, but do not exceed ⅝± 1/16 inch in diameter,
ii) a second component of Portland cement, and
iii) a third component of a recycled glass powder having a size of 325 mesh minus,
with said first, second and third components mixed with sufficient water to form a concrete with a total gravitational slump not exceeding 2 inches in a ASTM C 143 slump test, the concrete compacted and vibrated into a molded block having a length, the molded block cured, and the cured molded block cut transverse to its length into a plurality of tiles, wherein at each cut at least one of the faces of the tile is formed, and whereby the process of cutting exposes an inside of a portion of the aggregate that was not visible when the concrete was mixed,
said tile having uniform structural properties throughout its thickness.

2. A tile according to claim 1, wherein one of the first and second faces is polished.

3. A tile according to claim 1, wherein the individual grains of aggregate have a size up to but not exceeding ⅜ inch in diameter.

4. A tile according to claim 1, wherein the aggregate comprises recycled aggregate.

5. A tile according to claim 4, wherein the aggregate comprises post-consumer recycled aggregate.

6. A tile according to claim 1, wherein the recycled glass powder is a glass powder having 10-15% alkali content.

7. A tile according to claim 1, wherein a plurality of said tiles are arranged in a mosaic pattern and coupled together via a common backing material to form a composite mosaic tile.

8. A tile comprising:
a tile having first and second faces, and a thickness extending between the faces, the thickness being between ¼ inch and ¾ inch thick, the tile made of concrete mixed of
i) a first component of an aggregate having a size in which individual grains of the aggregate are cut by saw and staggered in displacement between the faces and on the faces, said aggregate comprising individual grains that are at or exceed ¼ inch in diameter but do not exceed ⅝± 1/16 inch in diameter,
ii) a second component of Portland cement, and
iii) a third component of a recycled glass powder having a size of 325 mesh minus,
with said first, second and third components mixed with sufficient water to form a concrete, the concrete compacted and vibrated into a molded block having a length, the molded block cured, and the cured molded block cut transverse to its length into a plurality of said tiles,
said tile having uniform structural properties throughout its thickness.

9. A tile according to claim 8, wherein the aggregate consists essentially of a first portion in which the individual grains have a diameter not exceeding ⅜ inch and a second portion in which the individual grains have a diameter exceeding ⅜ inch but not exceeding ⅝ inch± 1/16 inch.

10. A tile according to claim 8, wherein one of the first and second faces is polished.

11. A tile according to claim 8, wherein the aggregate comprises recycled aggregate.

12. A tile according to claim 11, wherein the aggregate comprises post-consumer recycled aggregate.

13. A tile according to claim 8, wherein the recycled glass powder is a glass powder having 10-15% alkali content.

14. A tile according to claim 8, wherein a plurality of said tiles are arranged in a mosaic pattern and coupled together via a common backing material to form a composite mosaic tile.

15. A tile made by a process comprising:
a) Mixing a concrete mix having,
i) a first component of an aggregate having a size in which individual grains of the aggregate having a diameter up to ⅝ inch but not exceeding ⅝± 1/16 inch,
ii) a second component of Portland cement,
iii) a third component of a recycled glass powder having a size of 325 mesh minus, and
iv) sufficient water such that said concrete mix has a total gravitational slump not exceeding 2 inches in a ASTM C 143 slump test,
b) forming said concrete mix into a block mold;
c) curing said molded concrete to form a concrete block with a height, a depth and a width;
d) cutting said concrete block into slices to define separate tiles with first and second faces extending parallel to said height and depth, and a thickness extending between said first and second faces, said thickness not exceeding ¾ inch; and
e) polishing at least one of said first and second faces.

16. A tile according to claim 15, wherein:
said forming includes forcing said concrete mix into said mold under compaction.

17. A tile according to claim 15, wherein:
said forming includes forcing said concrete mix into said mold under vibration.

18. A tile according to claim 15, wherein:
said cutting includes cutting with a gang saw.

19. A tile according to claim 15, wherein:
said cutting cuts through the aggregate to expose interior surfaces of the aggregate.

20. A tile according to claim 15, wherein:
said thickness of said tile does not exceed ¾ inch.

21. A tile according to claim 15, wherein:
said aggregate has individual grains up to but not exceeding ½ inch.

22. A tile according to claim 15, wherein:
said aggregate includes recycled materials.

23. A tile according to claim 15, wherein:
said aggregate includes post-consumer recycled materials.

24. A tile made by a process comprising:
a) mixing a concrete mix having,
i) a first component of an aggregate having a size in which individual grains of the aggregate have a diameter up to ⅝ inch but not exceeding ⅝± 1/16 inch,
ii) a second component of Portland cement, and
iii) sufficient water such that said concrete mix has a total gravitational slump not exceeding 2 inches in a ASTM C 143 slump test,
b) forming said concrete mix into a block mold;
c) curing said molded concrete to form a concrete block with a height, a depth and a width; and
d) cutting said concrete block into slices to define separate tiles with first and second faces extending parallel to said height and depth, and a thickness extending between said first and second faces, said thickness not exceeding ¾ inch; and

25. A tile according to claim 24, wherein:
said concrete mix further comprises a component of a recycled glass powder having a size of 325 mesh minus.

26. A tile according to claim 24, further comprising:
finishing at least one of said first and second faces.

27. A method of making a concrete tile, comprising:
a) mixing a concrete mix having,
i) a first component of an aggregate having a size in which individual grains of the aggregate have a diameter up to ⅝ inch but not exceeding ⅝± 1/16 inch,
ii) a second component of Portland cement,
iii) a third component of a recycled glass powder having a size of 325 mesh minus, and
iv) sufficient water such that said concrete mix has a total gravitational slump not exceeding 2 inches in a ASTM C 143 slump test,
b) forming said concrete mix into a block mold;
c) curing said molded concrete to form a concrete block with a height, a depth and a width;
d) cutting said concrete block into slices to define separate tiles with first and second faces extending parallel to said height and depth, and a thickness extending between said first and second faces, said thickness not exceeding ¾ inch.
